(19) United States
(12) Patent Application Publication
(10) Pub. No.: US 2014/0069006 A1
(43) Pub. Date: Mar. 13, 2014

(54) PLANT CONTAINER STABILIZER

(71) Applicant: Nicolay Family Enterprises, L.L.C., Fairway, KS (US)

(72) Inventors: Kenneth M. Nicolay, Fairway, KS (US); Lawrence E. Guerra, Mission, KS (US)

(73) Assignee: NICOLAY FAMILY ENTERPRISES, L.L.C., Fairway, KS (US)

(21) Appl. No.: 14/081,788

(22) Filed: Nov. 15, 2013

Related U.S. Application Data
(63) Continuation-in-part of application No. 29/406,969, filed on Nov. 21, 2011.

(51) Int. Cl. A01G 9/02

(52) U.S. Cl. CPC A01G 9/02
USPC 47/65.5

(57) ABSTRACT

A plant container stabilizer. The stabilizer has a frustoconical body formed by a hollow wall. The body includes an open top in which a container for a plant can be disposed. Ports are provided along the exterior of the body to enable installation of a ballast material into the hollow wall. A collar is provided about the open top of the body and includes bayonet-style slots disposed therein. Tabs may be provided on an exterior sidewall of the container for engagement with the slots of the collar to provide a locking engagement between the container and the stabilizer. The wide base of the stabilizer and the added weight provided by the ballast material increase the resistance of the container to tipping or toppling over such as when subjected to winds. The stabilizer is further configured to enable nestable stacking of a plurality of the stabilizers for shipment or storage.

### CROSS-REFERENCE TO RELATED APPLICATIONS

This application claims the benefit of U.S. Design patent application Ser. No. 29/406,969 filed Nov. 21, 2011 and titled “Plant Container Stabilizer” the disclosure of which is hereby incorporated herein in its entirety by reference.

### BACKGROUND

Potted plants are often placed outdoors for decorative purposes and to aid growing of the plants by exposing the plants to sunlight, moisture, and other environmental conditions. However, these conditions often include wind which can cause the pots to be blown or toppled over thus damaging the plant and pot as well as spilling the contents of the pot.

Many attempts have been made to provide stability against toppling of potted plants placed outdoors. These include providing a base or other component having increased dimensions, anchoring the pot or plant to the ground or other surface, and disposing the pot in the ground. Each of these known solutions includes drawbacks such as complexity in installation, permanency of installation, and lack of aesthetic appeal.

An aesthetically appealing simple solution to toppling of windblown potted plants is needed. Such a solution that is also configured for compact and easy storage and shipping is also needed.

### SUMMARY

Embodiments of the invention are defined by the claims below, not this summary. A high-level overview of various aspects of the invention are provided here for that reason, to provide an overview of the disclosure, and to introduce a selection of concepts that are further described in the Detailed-Description section below.

In brief, this disclosure describes, among other things, a potted plant container and stabilizer base. The container includes a hollow, generally cylindrical sidewall with a closed bottom end and an open top end. A flange is provided about the top end and one or more locking tabs may be provided on an exterior surface of the sidewall and adjacent the top end. The base is comprised of a hollow wall that forms a frusto-conical body. The body includes an opening at a top end thereof that is sized to receive the container therein. Slots may be provided about the opening for receiving locking tabs in a bayonet-style engagement for locking the container within the stabilizer base. At least one port (a first port) is provided in the hollow wall to enable filling of the space or cavity formed by the hollow wall with a flowable ballast material, such as water or sand. A second opening or port is formed in the hollow wall to allow air to escape as the cavity is filled or to enter the cavity to prevent the creation of a vacuum to resist the flow of ballast out of the first port. One or more handles, structural reinforcement elements, or similar features might also be molded in to the wall of the stabilizer base.

The stabilizer base thus provides resistance against toppling of the container, and a plant potted therein, through provision of additional weight from the ballast material and through increased dimensions of the base relative to the container. The container may also be locked into the stabilizer base to prevent lifting or toppling of the container out of the stabilizer base.

### DESCRIPTION OF THE DRAWINGS

Illustrative embodiments of the invention are described in detail below with reference to the attached drawing figures, and wherein:

FIG. 1 is a perspective view of a plant container stabilizer depicted in accordance with an embodiment of the invention;

FIG. 2 is a top plan view of the plant container stabilizer of FIG. 1;

FIG. 3 is a right side view of the plant container stabilizer of FIG. 1;

FIG. 4 is a front elevational view of the plant container stabilizer of FIG. 1;

FIG. 5 is a bottom plan view of the plant container stabilizer of FIG. 1;

FIG. 6 a rear elevational view of the plant container stabilizer of FIG. 1;

FIG. 7 is a side elevational view of two of the plant container stabilizers of FIG. 1 depicted in a nested, stacked configuration;

FIG. 8 is a cross-sectional side view of the stacked plant container stabilizers of FIG. 7 depicted in accordance with an embodiment of the invention;

FIG. 9 is a perspective view of a plant container stabilizer and a container that is disengaged from the plant container stabilizer depicted in accordance with another embodiment of the invention;

FIG. 10 is a perspective view of the plant container stabilizer of FIG. 9 with the container engaged therein;

FIG. 11 is a cross-sectional elevation view depicting two of the plant container stabilizers of FIG. 9 in a stacked orientation in accordance with an embodiment of the invention

FIG. 12 is a perspective view of a plant container stabilizer with a fill port in a top edge thereof depicted in accordance with an embodiment of the invention; and

FIG. 13 is a bottom plan view of the plant container stabilizer of FIG. 12 depicting a drain port disposed in a bottom wall thereof.

### DETAILED DESCRIPTION

The subject matter of select embodiments of the invention is described with specificity herein to meet statutory requirements. But the description itself is not intended to necessarily limit the scope of claims. Rather, the subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

Embodiments of the invention are described herein with respect to the drawings in which reference numerals are employed to identify particular components or features. Corresponding elements in the various embodiments depicted are provided with reference numerals having matching second and third digits but with differing first digits, e.g. element 10 corresponds to elements 110, 210, etc. Such is provided to avoid redundant description of corresponding features of the elements but is not intended to indicate the features or elements are necessarily the same.

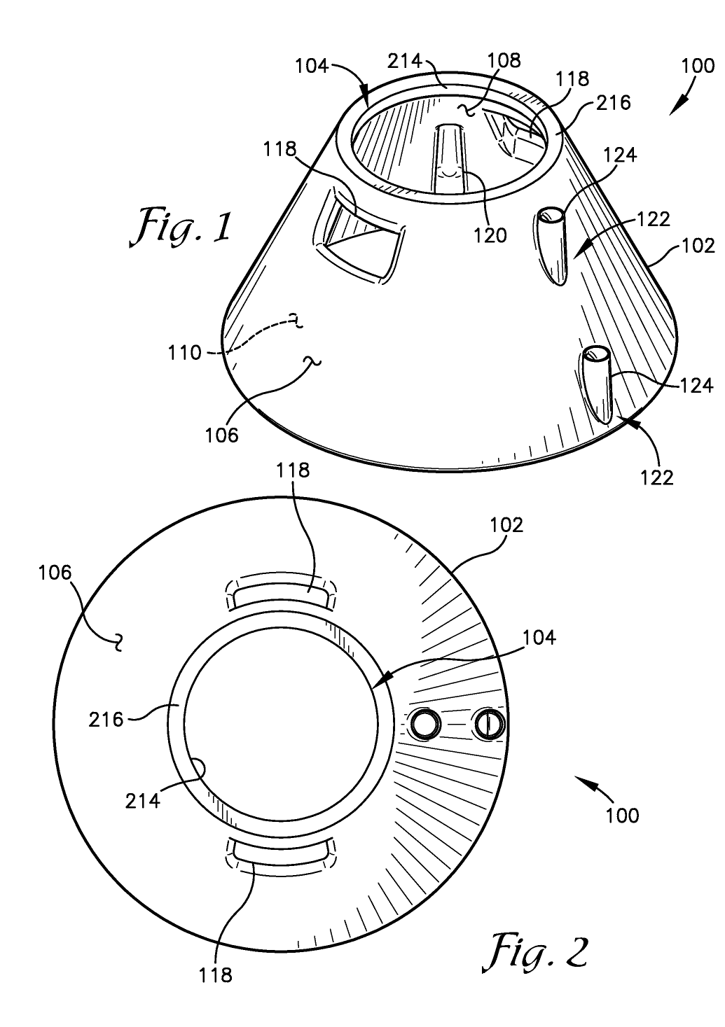

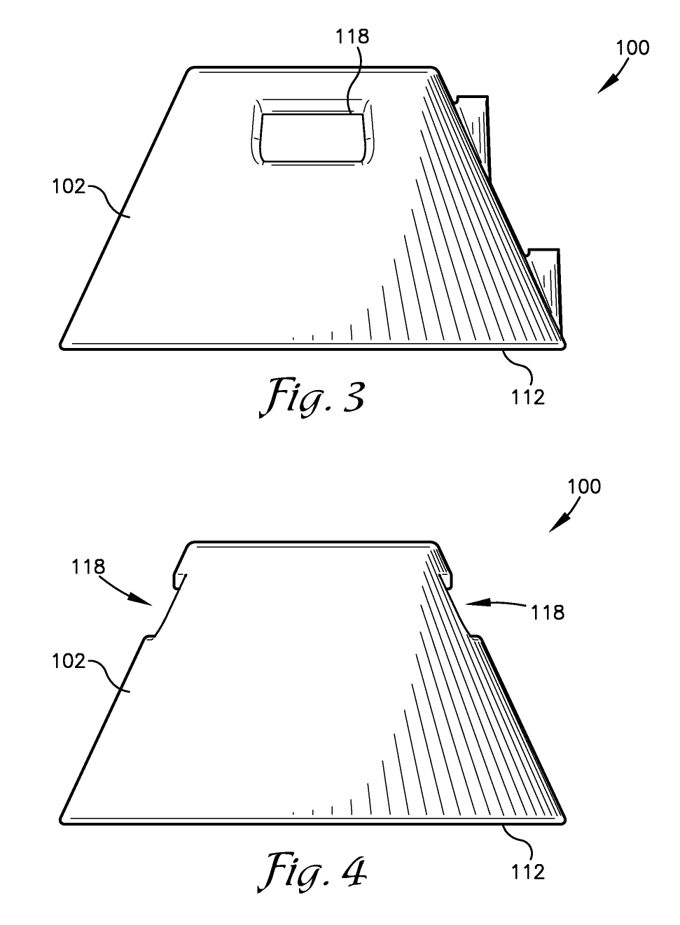

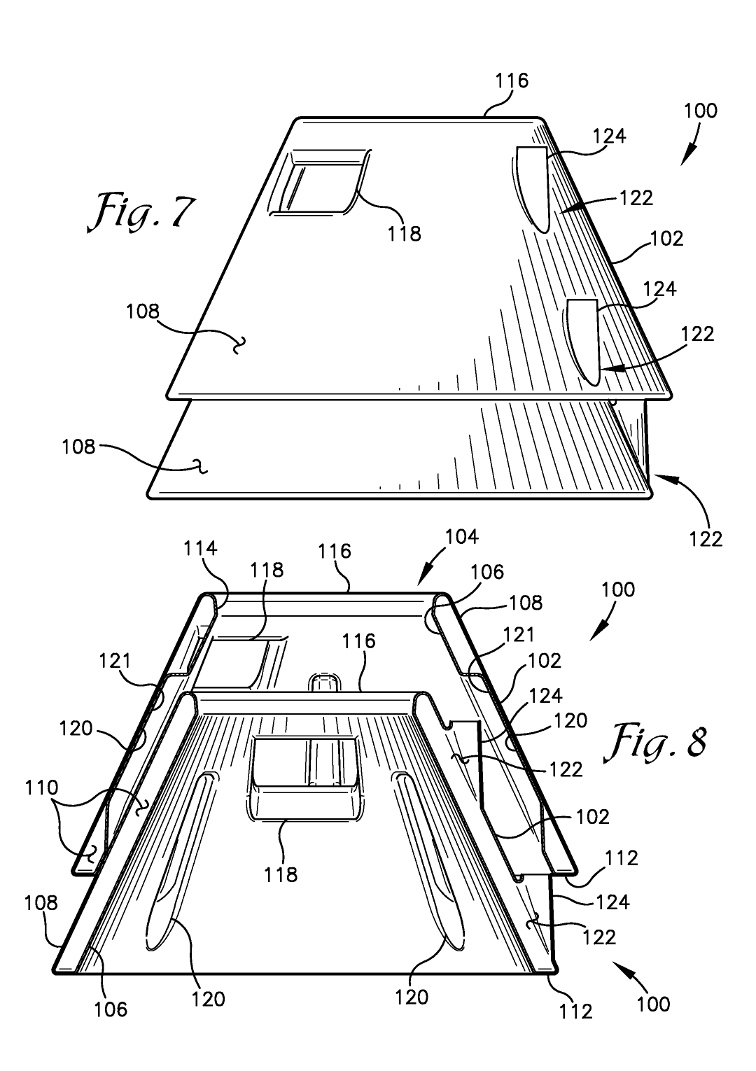

With initial reference to FIGS. 1-8, a plant container stabilizer 100 is described in accordance with an embodiment of the invention. The plant container stabilizer 100, or simply, the stabilizer 100 comprises a body 102 having a frustoconical form with an opening 104 at a top end thereof. Other forms or shapes can be employed for the body 102, e.g. pyramidal, cuboidal, or the like—such forms are within the scope of embodiments of the invention described herein. Preferably, the form of the body 102 includes a bottom portion with greater dimensions, e.g. diameter, than that of a container (not shown) that may be disposed therein. And preferably, the form of the body 102 includes a bottom portion with dimensions that are greater than that of a top portion thereof such that a plurality of stabilizers 100 can be stacked in a nested orientation as generally shown in FIGS. 7 and 8. The bottom portion of the body 102 is preferably open but may include a floor (not shown) thereacross.

As best shown in FIG. 8, the body 102 includes substantially parallel, spaced-apart, inner and outer walls 106, 108 that provide a closed, hollow interior space or ballast receiving cavity 110. A substantially horizontal bottom wall 112 connects bottom edges of the inner and outer walls 106, 108 to form a surface on which the body 102 rests when placed on the ground or other surface. A substantially vertical collar 114 extends between the top ends of the inner and outer walls 106, 108 and defines the opening 104. The outer wall 108 may be at least partially rounded off or curved inwardly toward a top of the collar 114 to provide a top edge 116 of the body 102.

The body 102 also optionally includes one or more handles 118, cutouts, surface ornamentations, or similar features molded or formed therein. In an alternative embodiment, the handles, surface ornamentations, or similar features are coupled, attached, or affixed to the outer wall 108.

The inner wall 106 includes a plurality of reinforcement elements 120 molded or formed therein and extending generally between the bottom and top edges of the inner wall 106. The reinforcement elements 120 comprise portions of the inner wall 106 that are depressed into the space 110. The elements 120 may contact and/or attach to the outer wall 108 or may be spaced apart therefrom. The elements provide additional strength to the inner wall 106 to resist bowing or bending thereof when under loads placed on the inner wall 106 during use of the stabilizer 100. Contact and/or attachment between the elements 120 and the outer wall 108 may also aid to strengthen the outer wall 108 and resist bowing or bending thereof when under load.

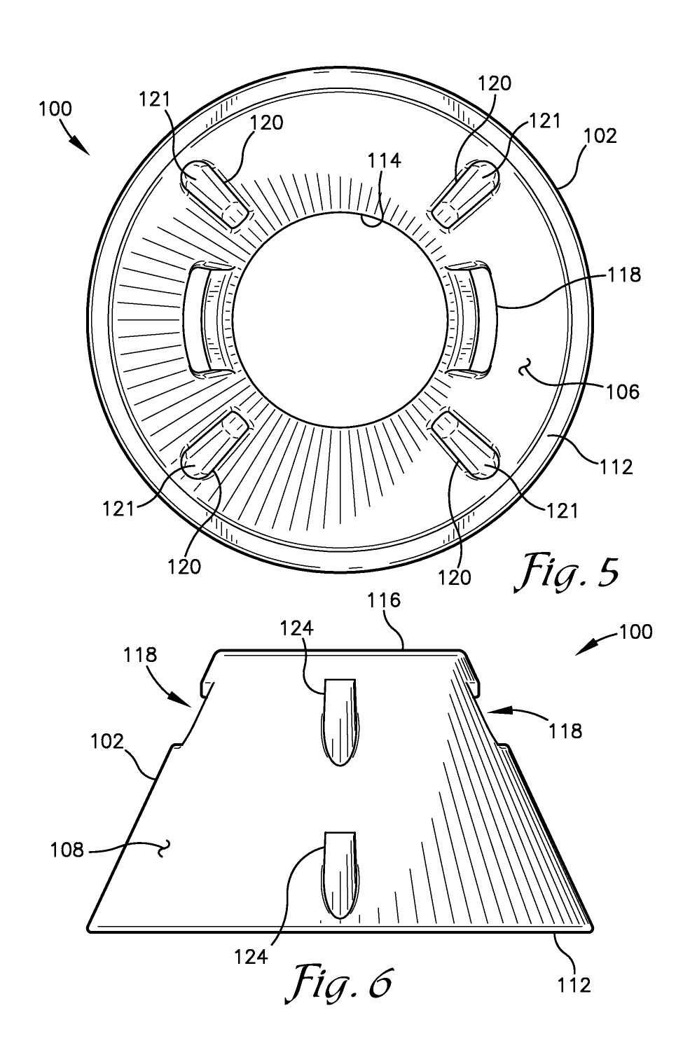

The reinforcement elements 120 shown are generally formed as a continuous wall surrounding or defining a vertically extending recess or groove 121 opening through inner wall 106 towards an interior of the stabilizer body 102. The reinforcement elements 120 are preferably equally or uniformly spaced around the inner wall 106. Four reinforcement elements 120 are shown in FIG. 5. The reinforcement elements are preferably sized to facilitate stacking or nesting of one stabilizer 100 on top of another as discussed in more detail hereafter.

The body 102 also includes a pair of ports 122 disposed in the outer wall 108 that provide access to the hollow space 110 within the body 102. As depicted in FIGS. 1-6, the ports 122 are aligned generally vertically along a side of the body 102 with one port 122 near the bottom of the body 102 and the second port near the top of the body 102 however other arrangements may be employed. The ports 122 are each in communication with the space 110 such that one port 122 can function as a vent while ballast material is installed in or removed via the second port 122.

The ports 122 are formed in tubular extensions 124 coupled to the outer wall 108 and extending vertically therefrom. The tubular extensions or bosses 124 are integrally molded with the outer wall 108 or may be fixedly or removeably coupled thereto. In an embodiment, distal ends of the tubular extensions 124 include a threaded mouth to which a hose or similar apparatus can be coupled for provision of a liquid into the space 110 via one of the ports 122. Caps or plugs (not shown) can also be provided to close off the openings of the extensions 124 or ports 122. It is to be understood that the tubular extensions 124 can be removed and replaced with a cap or plug.

With continued reference to FIGS. 1-8, use of the plant container stabilizer 100 is described in accordance with an embodiment of the invention. The hollow space 110 of the container 100 is filled with a ballast material, such as water, sand, or other flowable material. The ballast material is supplied to one of the ports 122, such as by attaching a hose or similar apparatus thereto and flowing the ballast material therethrough. Alternatively, the ballast material might be poured from a container into the selected port 122, among other methods. At least one of the ports 122, or a first port, is sized to permit ballast material to be poured therethrough. A second of the ports 122 is sized to allow air to escape the interior space 110 displaced by ballast material poured therein and to allow ballast material to flow into the space 110 as ballast material is poured out of the space 110 to prevent formation of a vacuum and to aid flow of ballast out of the ballast receiving cavity 110. The stabilizer 100 may be emptied of ballast when not in use or to facilitate movement to a different location.

The quantity of ballast material supplied to the space 110 is selectable based on a weight of the stabilizer 100 that is desired. The ballast material can be installed with the stabilizer 100 generally level on a ground surface and in any quantity desired up to a maximum quantity at which the lower port 122 begins to overflow. Alternatively, if a greater amount of ballast material is desired, the stabilizer 100 can be temporarily tipped up on edge to enable a greater amount of the space 110 to be filled before overflowing the ports 122. In such a situation, plugs or caps must be installed on the tubular extensions 124 or ports 122 prior to returning the stabilizer 100 to a level orientation.

After filling the space 110 with a desired quantity of ballast material, plugs or caps may be installed on the tubular extensions 124 to close off the space 110. The plugs or caps prevent evaporation of water when used as the ballast material, inadvertent spilling of the ballast material, as well as access to the space 110 by insects and other debris. In one embodiment, the tubular extensions 124 are removable and are replaced with plugs or caps after filling.

A container in which a plant has been planted and that has at least a lower portion with dimensions smaller than that of the opening 104 can be placed in the stabilizer 100 by inserting the lower portion of the container into the opening 104. The container may have sufficient length to contact the ground surface within the stabilizer 100 and thereby support the container. The container may additionally or alternatively include an annular flange or other configuration (e.g. an enlarged upper portion or an inverted conical form, among others) having dimensions greater than that of the opening 104. The annular flange can thus engage the top edge 116 of the stabilizer 100 to support the container in a hanging fashion.

The container is thus provided with a stabilizer 100 that has larger dimensions than that of the container and with increased weight. The larger dimensions of the stabilizer 100 relative to the container increases the lever arm about which the container must pivot in order to tip or topple over. The increased weight further resists such movements of the container about the lever arm.

When it is desired to move the stabilizer 100 or to empty the ballast material therefrom, the plugs or caps (if supplied) are removed and the stabilizer tipped on edge to drain the ballast material from at least one of the ports 122. The second of the ports 122 may act as a vent during draining to enable air to enter the space 110 to replace the ballast material.

The stabilizers 100 are sized and shaped to facilitate stacking of one on top of the other or nesting of one within the other. The base of each stabilizer is wider than the top so that the base of one stabilizer fits over the top of another. More specifically the diameter across the inner wall 106 of the stabilizer adjacent the bottom wall 112 is wider than the diameter across the outer wall 108 adjacent the collar 114 or top of the stabilizer. In addition, the vertically extending grooves 121 formed in the inner wall 106 may be sized to receive the bosses or tubular extensions 124 to facilitate stacking

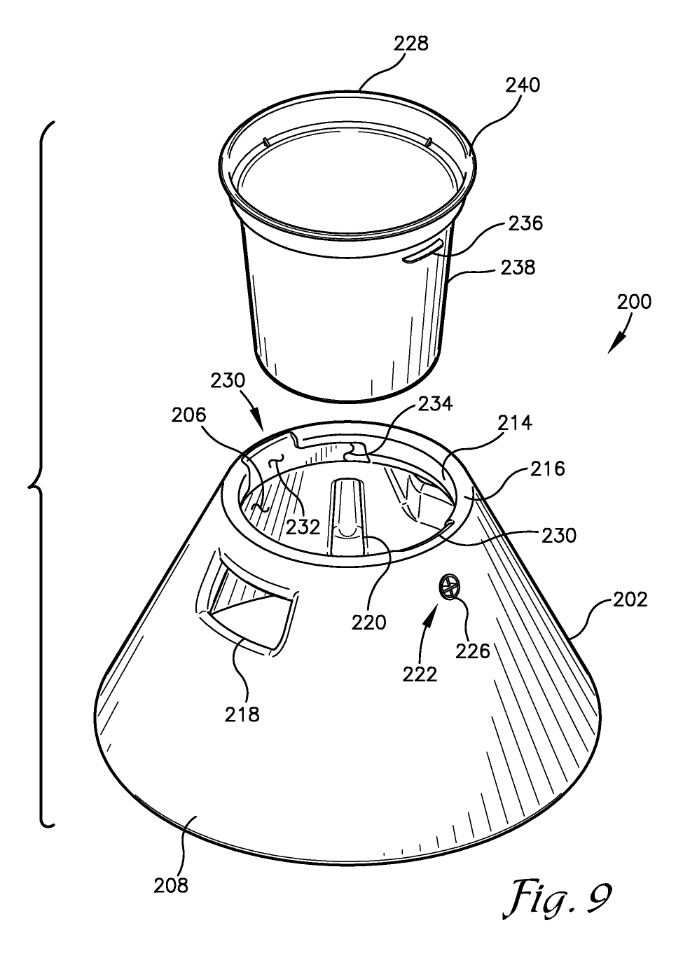

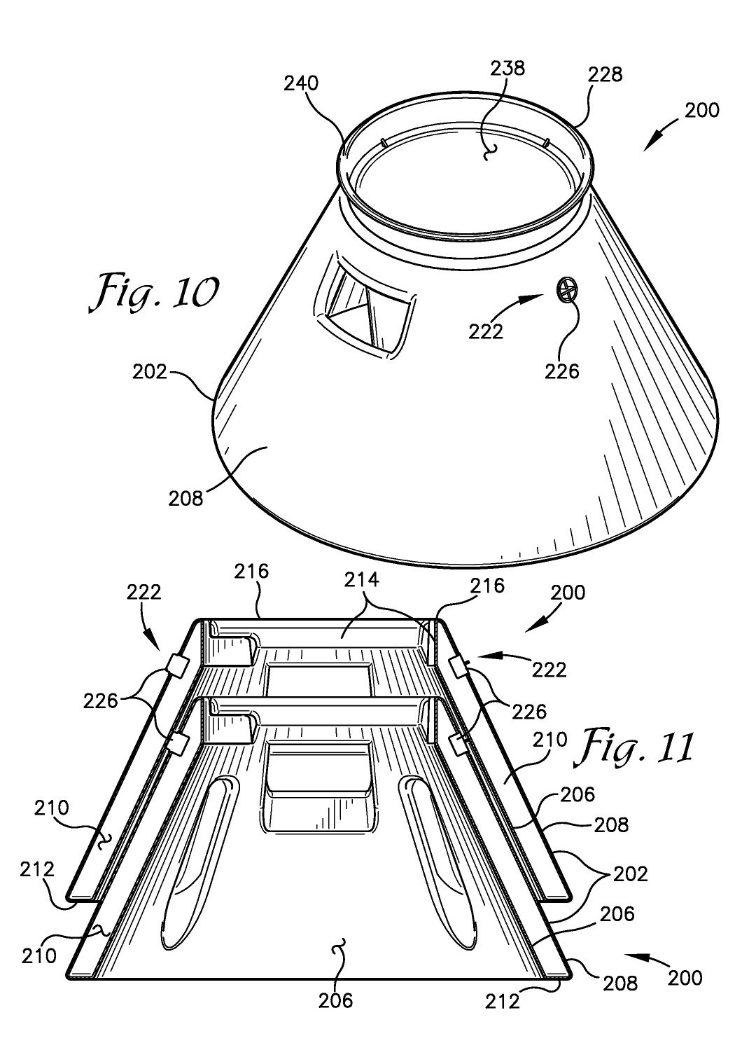

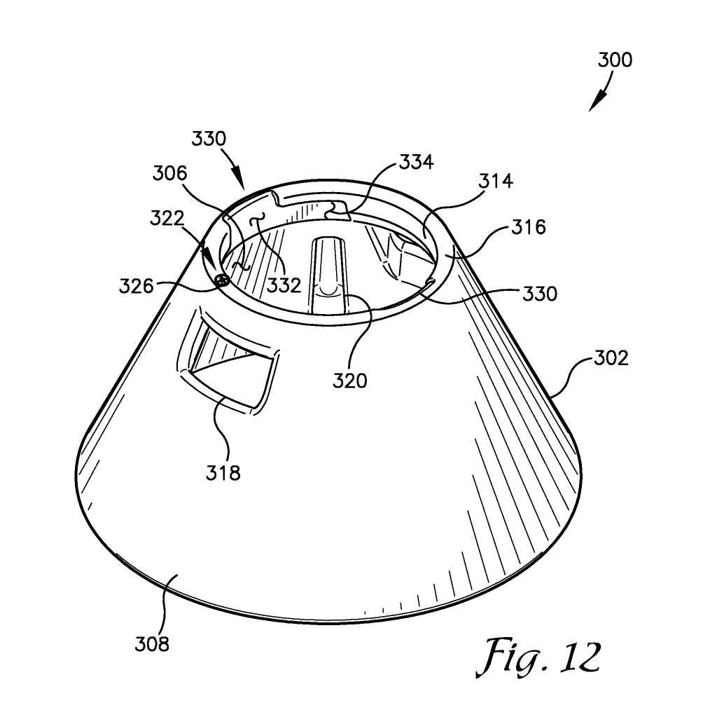

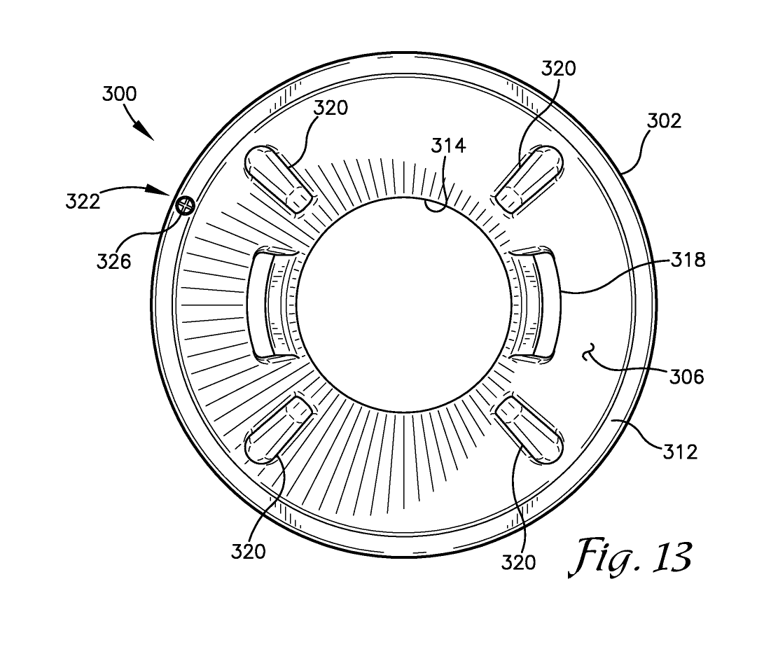

With additional reference now to FIGS. 9-11, a plant container stabilizer 200 is described in accordance with another embodiment of the invention. The stabilizer 200 includes features similar to those of the stabilizer 100 and as such those features are not described in detail again here except to where necessary to describe differences therebetween. The body 202 includes ports 222 disposed on diametrically opposite sides of the body 202 and in a common horizontal plane, e.g. equidistant from the top edge 216 of the body 202. It is understood that the ports 222 might be disposed in any desired position on the body 202. For example the ports 222 can be disposed in the outer wall 208, inner wall 106 or as depicted in FIGS. 12-13 in a top edge 316 and a bottom wall 312.

Plugs 226 are provided in the ports 222 to close off access to the hollow space 210 within the body 202. The plugs 226 can be threaded for receipt by mating threads disposed about the ports 222 or can be compression- or friction-fit into the port openings, among other available ways for receiving and retaining the plugs 226 within the port openings. The plugs 226 are configured to lie substantially flush with the outer wall 208 of the stabilizer 200.

The collar 214 of the stabilizer 200 is configured to provide locking engagement with a container 228 or pot that is installed in the stabilizer 200. The collar 214 includes one or more bayonet-style slots 230. The slots 230 include a first substantially vertical portion 232 that is open to the top edge 216 and extends vertically along the collar 214 to a second substantially horizontal portion 234. The second portion 234 extends a distance circumferentially around the collar 214.

The container 228 includes one or more tabs 236 extending radially outward from a sidewall 238 thereof. The tabs 236 are configured for alignment and receipt vertically into the first portion 232 of the slots 230. The container 228 is then rotatable relative to the slots 230 to engage the tabs 236 in the second portion 234 of the slots 230 and thereby lock the container 228 against vertical removal from the stabilizer 200. The slots 230 can include one or more features, such as detents, dimples, or the like (not shown) to provide resistance to unwanted rotation of the container 228 in the opposite direction. The slots 230 might alternatively be configured as downwardly sloping elongate slots that travel circumferentially about the collar 214 in a manner similar to threads, or in another available configuration without departing from the scope of embodiments of the invention descried herein.

The container 228 also includes an annular flange 240 at a top end thereof. The annular flange 240 can engage or rest upon the top edge 216 of the stabilizer 200 to support the container 228 thereon. In some embodiments, the container 228 has a height sufficient to contact a ground surface on which the stabilizer 200 is placed when the container 228 is disposed within the stabilizer 200; the contact with the ground surface can thus provide additional support for the container 228.

As depicted in FIG. 9, the stabilizer 200 is configured to enable stacking of a plurality of the stabilizers 200 in a nested configuration in which a first stabilizer 200 is at least partially received within the interior of another stabilizer 200. As such, shipping and/or storage of the stabilizers 200 is very compact and requires a reduced amount of space.

Operation of the stabilizer 200 is similar to that of the stabilizer 100 except that tipping of the stabilizer 200 to aid additional filling of the space 210 may not be necessary due to the placement of the ports 222 near the top of the stabilizer 200. Additionally, installation of the container 228 into the opening 204 includes alignment of the tabs 136 on the container 228 with the slots 230 and rotation of the container 230 relative to the slots 230 to engage the bayonet-style coupling therebetween.

In another embodiment, the stabilizers 100, 200 might be configured to receive and support other apparatus. For example, the stabilizers 100, 200 might be configured to support flag poles, poles for volleyball, tennis, or similar nets, hammock support posts, temporary fence posts, or sign posts, among a variety of other vertically standing objects.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A plant container stabilizer comprising:
a frustoconical body having an open top end, the body formed by a hollow wall defining a ballast receiving cavity;
at least one port disposed in an outer surface of the body in communication with the ballast receiving cavity and sized to permit filling of said ballast receiving cavity with a flowable ballast; and
a container disposed in the body via the open top end and supported against toppling by the body.

2. The plant container stabilizer of claim 1, further comprising:
a collar defining the open top end, the collar including a bayonet-style slot formed therein; and
a tab extending radially outwardly from a sidewall of the container and configured for receipt by the slot to lockingly engage the container with the body.

3. The plant container stabilizer of claim 1, further comprising:
a plug removably securable in said at least one port.

4. The plant container stabilizer of claim 1, further comprising:
a handle molded in to the body.

5. The plant container stabilizer of claim 1, further comprising:
a tubular extension extending vertically upward from said at least one port.

6. The plant container stabilizer of claim 1, wherein said at least one port comprises a pair of ports disposed adjacent a top end of the body and on diametrically opposite sides of the body.

7. The plant container stabilizer of claim 6, wherein the ports in the pair of ports are vertically aligned and spaced apart along one side of the body.

8. The plant container stabilizer of claim 1, wherein the body is nestably stackable with a second similarly configured body.

9. The plant container stabilizer of claim 1, wherein the hollow wall comprises an inner wall, an outer wall, a collar extending between upper ends of the inner and outer walls and a substantially horizontal bottom wall extending between lower ends of the inner and outer walls.

10. The plant container stabilizer of claim 9, wherein the inner wall includes one or more reinforcement elements molded therein that reinforce the inner wall against bending.
